(19) United States
(12) Patent Application Publication
(10) Pub. No.: US 2009/0267477 A1
(43) Pub. Date: Oct. 29, 2009

(54) ELECTRICAL LIGHT SOURCE, IN PARTICULAR FOR USE IN A REFLECTOR

(76) Inventors: Joachim Arndt, Brieselang (DE); Uwe Fidler, Berlin (DE); Markus Herb, Langenau (DE); Matthias Lenz, Falkensee (DE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/311,956

(22) PCT Filed: Oct. 12, 2007
(86) PCT No.: PCT/EP2007/060874

§ 371 Date: May 1, 2009

(30) Foreign Application Priority Data
Oct. 23, 2006 (DE) 10 2006 049 908.5

(51) Int. Cl. H01K 1/26; H01J 5/00; H01K 1/46

(52) U.S. Cl. 313/113; 313/317; 313/634

(57) ABSTRACT

The light source has external electrical power supply lines which are held in contact pins in the cap. The connection is made by crimping, with the electrical power supply line in each case having a plurality of notches.

### TECHNICAL FIELD

The invention proceeds from an electric light source in accordance with the preamble of claim 1. What is involved here is, in particular, reflector lamps based on high pressure discharge lamps such as metal halide lamps, or else sodium high pressure discharge lamps. The discharge vessel is generally accommodated in an outer bulb. However, the invention can also be applied in the case of reflector lamps based on halogen incandescent lamps, or similar. Furthermore, a lamp that is intended for use in a reflector luminaire can be involved.

### PRIOR ART

WO 2004046609 discloses a metal halide lamp provided with a reflector and having a ceramic discharge vessel. To provide the lamp with a base, the supply leads of this lamp, which are located in the base pins of the base after preassembly and protrude at the end thereof, are permanently fused to the pin material by means of suitable welding methods. In this case, the supply lead is guided out of the outer bulb and welded or soldered in a base pin. Such a method certainly provides a secure connection, but it is difficult in this case to set and keep the correct light center for the lamp in the reflector.

Another possibility for the connection is crimping, that is to say the deformation of the metal pins with the aid of compression methods. CA 2 513 931 discloses a halogen incandescent lamp in the case of which a supply lead which is guided out of an outer bulb is held in a coated pin by means of crimping the pin. However, this requires a very soft material for the supply lead, which cannot always be applied. Similarly, it is shown in DD 295 274 that the supply lead has an additional indentation. When a soft material (for example nickel) is crimped onto a hard or tough material (for example molybdenum) the known technique is associated with the risk of the connection loosening again. This can lead to flashovers and sputtering and, moreover, to defocusing of the midpoint of the burner.

### SUMMARY OF THE INVENTION

The object of the present invention is to specify an electric light source, in particular for use in a reflector, that enables a permanent simple connection and, in particular, enables an optical adjustment of the light source in a reflector.

This object is achieved by characterizing features of claim 1.

Particularly advantageous refinements are to be found in the dependent claims.

According to the invention, the outer supply leads of the light source are respectively provided with a plurality of notches, the supply lead being produced from a tough and/or hard material, in particular molybdenum or the like, and at least one base pin that is crimped in the region of the notches being used for fastening purposes.

The minimum number of notches is two, preferably at least three. The crimping should extend at least to one notch, preferably over at least two notches. It is possible in principle to use only one notch, but this then provides only a minimal adaptability that depends only on the length of the crimping.

According to the invention, the supply leads of a light source—also denoted here as base lamp—are fixed in the metal contacts—often also denoted here as base pin—of a base, preferably a ceramic base, by means of crimping. In this case, the supply lead to be fixed is provided with notches such as indentations or slots or circumferential constrictions. This effects a positive connection between pin material and the material of the supply lead.

A secure electric contact between the base pin and supply lead of the base lamp is thereby achieved. This effects mechanical fixing of the base lamp, in particular of the luminous means, which is mostly arranged at the midpoint of the bulb, in the structural focal point of a reflector after adjustment during the installation in the reflector.

The supply leads projecting from the base lamp are provided according to the invention inside a defined length with a plurality of indentations. The length is to be selected such that the subsequent crimping region is covered.

The shape of the notches can be different in this case.

A positive connection is produced that can no longer be loosened given normal loading. The strength of the connection is substantially increased. The interlocked materials prevent the connection from loosening, for example, owing to transportation of the lamps.

In principle, this type of crimping can also be applied in the case of other light sources that involve a permanent adjustment or an unwelded connection.

The inner vessel can be a discharge vessel alone or with an outer bulb. It can also be the bulb of a halogen incandescent lamp. The base is preferably made from ceramic.

In detail, a reflector lamp is presented that has an inner vessel which is fixed in a reflector, the inner vessel being held in a base with at least one contact pin having a bore. An outer supply lead that projects from the inner vessel is introduced into the bore in the contact pin and held there by means of crimping, the supply lead being provided with a plurality of notches, and the contact pin being crimped onto the supply lead.

A particularly reliable holding is achieved by crimping the contact pin onto the supply lead such that the crimping length covers at least two of the notches.

The supply lead is preferably made from molybdenum such that the lamp can be operated in air. The base pin is preferably made from soft material that can be effectively crimped. In particular, the contact pin is made from brass, copper or nickel or an alloy thereof.

One preferred particular application is a reflector lamp having an inner vessel that contains a discharge vessel with a metal halide filling as sole vessel, or else held in an outer bulb.

### BRIEF DESCRIPTION OF THE DRAWINGS

The invention is to be explained in more detail below with the aid of a number of exemplary embodiments. In the figures:

FIG. 1 shows the side view of a reflector lamp;

FIG. 2 shows the inner vessel of the reflector lamp of FIG. 1;

FIG. 3 shows the illustration, rotated by 90°, of the inner vessel from FIG. 2, without base;

FIG. 4 shows further exemplary embodiments of the supply leads with notches; and

FIG. 5 shows the production of the crimp.

### PREFERRED DESIGN OF THE INVENTION

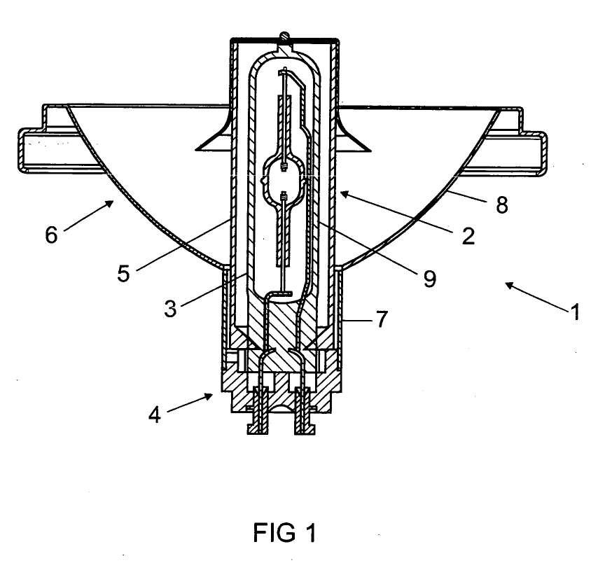

Shown in FIG. 1 is a reflector lamp 1 having an inner vessel 2 consisting of a discharge vessel 3 that is surrounded by an outer bulb 9. The inner vessel 2 is seated in a central opening in a base 4. The inner vessel 2 is surrounded at a spacing by an anti-burst protective tube 5 that is of cylindrical configuration and aligned in an axially parallel fashion. The anti-burst protective tube 5 itself is in turn surrounded by a reflector 6 consisting of aluminum. The reflector has a neck 7 and a contour 8. The diameter of the neck is advantageously adapted to the diameter of the anti-burst protective tube from the outside. Both parts are mounted on the base 4 consisting of ceramic.

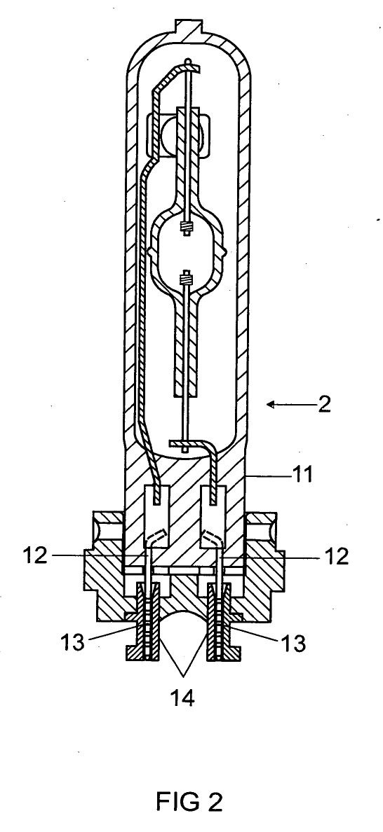

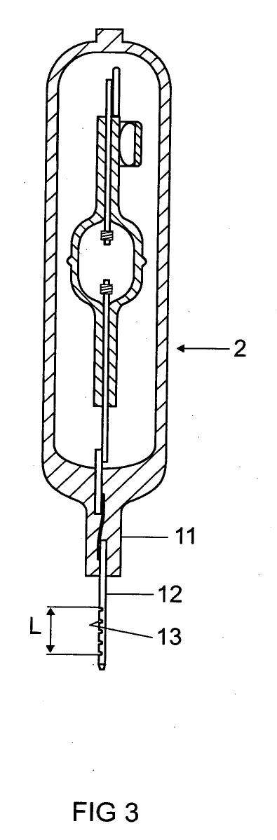

FIG. 2 shows the inner vessel 2 in detail. Two supply leads 12 consisting of molybdenum, or else of a comparable material, are guided to the outside from the pinch 11 of the outer bulb. As is illustrated in FIG. 3, these are provided at one end with indentations 13 over a length L. The supply leads 12 plug into contact pins or base pins 14 (see FIG. 2).

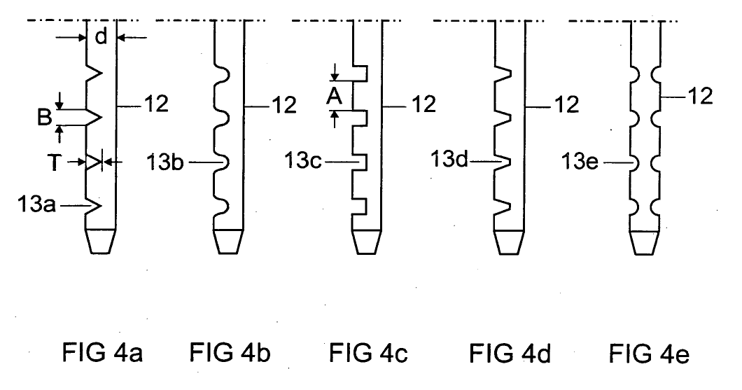

FIG. 4 shows alternatives to the configuration of the notches 13. They can be V-shaped 13a (FIG. 4a), or U-shaped 13b (FIG. 4b), or rectangular 13c (FIG. 4c), or trapezoidal 13d (FIG. 4d), or be configured as circumferential grooves 13e (FIG. 4e).

The width B of the notches preferably lies between 0.2 d and 1.0 d, d being the diameter of the supply lead 12. The depth T of the notches preferably lies between 0.2 d and 0.5 d. Depending on the length of the crimp zone and tolerance in the adjustment, the number of the notches can lie between 1 and 10, preferably between 2 and 10, notches. The spacing A between the notches preferably lies between 0.5 d and 1.0 d.

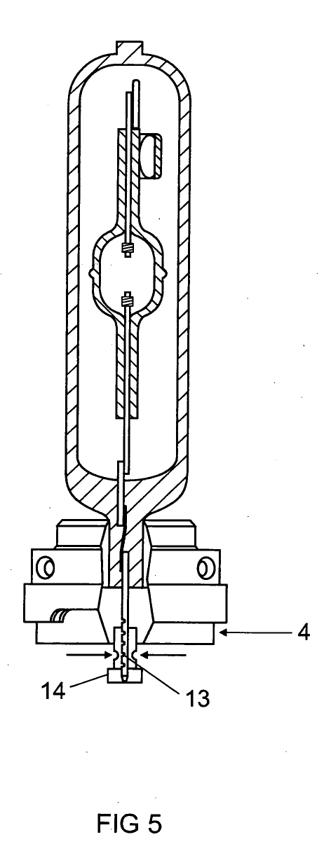

During the crimping operation (FIG. 5), the soft material of the base pin 14, which is already fixed in the base ceramic 4, is pressed into the notches 13 in the supply leads, or into a portion (shown here: one) of the notches (arrows), thus producing a positive, exactly adjusted connection.

The inner vessel can also be sealed at both ends, only one outer supply lead being guided into the neck of the reflector and being crimped there in accordance with the invention.

1. An electric light source, in particular for use in a reflector, having an inner vessel, the inner vessel being held in a base with at least one contact pin having a bore, characterized in that an outer supply lead that projects from the inner vessel is introduced into the bore in the contact pin and held there by means of crimping, the supply lead being provided with a plurality of notches, and the contact pin being crimped onto the supply lead.

2. The light source as claimed in claim 1, characterized in that the contact pin is crimped onto the supply lead such that the crimping length covers at least one of the notches.

3. The light source as clamed in claim 1, characterized in that the supply lead is made from molybdenum.

4. The light source as claimed in claim 1, characterized in that the contact pin is made from brass, copper or nickel or an alloy thereof.

5. The light source as claimed in claim 1, characterized in that the inner vessel contains a discharge vessel with a metal halide filling.

6. The light source as claimed in claim 1, characterized in that together with a reflector the light source forms a reflector lamp.

7. The light source as claimed in claim 2 wherein the crimping length covers at least two of the notches.
